(19) United States
(12) Patent Application Publication
(10) Pub. No.: US 2018/0023719 A1
(43) Pub. Date: Jan. 25, 2018

(54) EXHAUST SYSTEM AND CONTROL DEVICE

(71) Applicant: Shimadzu Corporation, Kyoto (JP)

(72) Inventors: Masaya NAKAMURA, Kyoto (JP); Kiyonori HIROTA, Kyoto (JP); Junichiro KOZAKI, Kyoto (JP); Nobuyuki HIRATA, Kyoto (JP); Atsuo NAKATANI, Kyoto (JP)

(21) Appl. No.: 15/619,957

(22) Filed: Jun. 12, 2017

(30) Foreign Application Priority Data
Jul. 22, 2016 (JP) 2016-144519

(51) Int. Cl. F16K 31/04; F16K 3/06; F16K 51/02; F16K 3/02

(52) U.S. Cl. CPC F16K 31/042; F16K 3/0254; F16K 3/06; F16K 31/04; F16K 51/02; F16K 3/16

(57) ABSTRACT

A control device configured to control each of a vacuum pump and a vacuum valve provided on a side of a suction port of the vacuum pump, the control device comprises: a motor driver configured to drive a rotor driving motor of the vacuum pump; a valve plate driver configured to drive a valve plate driving motor of the vacuum valve; and a controller configured to control the motor driver and the valve plate driver.

### TECHNICAL FIELD

The present invention relates to an exhaust system and a control device.

### BACKGROUND ART

Processes such as thin film treatment and etching are performed in vacuum apparatuses such as film forming equipment and etching equipment used to manufacture semiconductors, flat panel displays, touch screen panels, and the like. Such processes are performed in a state where the supply of gas is controlled in order to control the internal pressure of the chamber. As such, exhaust systems that include a conductance adjustable vacuum valve on the suction port side of the turbo-molecular pump are frequently used for the exhaust of the chamber. An example of a known conductance adjustable vacuum valve is recited in JP 2011-137537A.

However, in the related art, the turbo-molecular pump and the vacuum valve that constitute the exhaust system are provided individually. As such, the single exhaust system includes one control device for the pump and one control device for the valve, and each of these control devices is configured to individually communicate with an apparatus side host controller. Consequently, there is a problem in that space for two control devices is needed and the installation space for the exhaust system is increased. Additionally, cost is a problem.

### SUMMARY OF THE INVENTION

A control device configured to control each of a vacuum pump and a vacuum valve provided on a side of a suction port of the vacuum pump, the control device comprises: a motor driver configured to drive a rotor driving motor of the vacuum pump; a valve plate driver configured to drive a valve plate driving motor of the vacuum valve; and a controller configured to control the motor driver and the valve plate driver.

The control device further comprises: a power section configured to convert AC power to DC power and supply the DC power to each of the motor driver, the valve plate driver, and the controller.

The control device further comprises: a communication section configured to carry out communication related to valve operations and communication related to pump operations with an external device via a shared communication interface.

The control device according further comprises: a single temperature controller configured to control a pump side heater provided on the vacuum pump and a valve side heater provided on the vacuum valve.

An exhaust system comprises: a vacuum pump; a vacuum valve mounted on a suction port of the vacuum pump; and the control device.

The control device is provided on a base bottom surface of the vacuum pump. The control device is connected to the vacuum valve by connecting a cable to a connector provided on the control device and a connector provided on the vacuum valve.

The control device is provided on a side surface of a housing in which the valve plate driving motor is housed. The control device is connected to the vacuum pump by connecting a cable to a connector provided on the control device and a connector provided on the vacuum pump.

The control device is provided on a base side surface of the vacuum pump. The control device is directly connected to the vacuum valve by a connector.

According to an aspect of the invention, it is possible to miniaturize and reduce the cost of a control device in an apparatus in which a vacuum pump and a vacuum valve are used.

### BRIEF DESCRIPTION OF THE DRAWINGS

FIG. 1 is an appearance view of an exhaust system.

FIG. 2 is a block diagram illustrating a schematic configuration of the exhaust system.

FIG. 3 is a drawing illustrating a second disposal example of a control device.

FIG. 4 is a drawing illustrating a third disposal example of the control device.

FIG. 5 is a drawing illustrating a fourth disposal example of the control device.

FIG. 6 is a block diagram illustrating an alternate embodiment of the exhaust system.

### DETAILED DESCRIPTION OF THE EXEMPLARY EMBODIMENTS

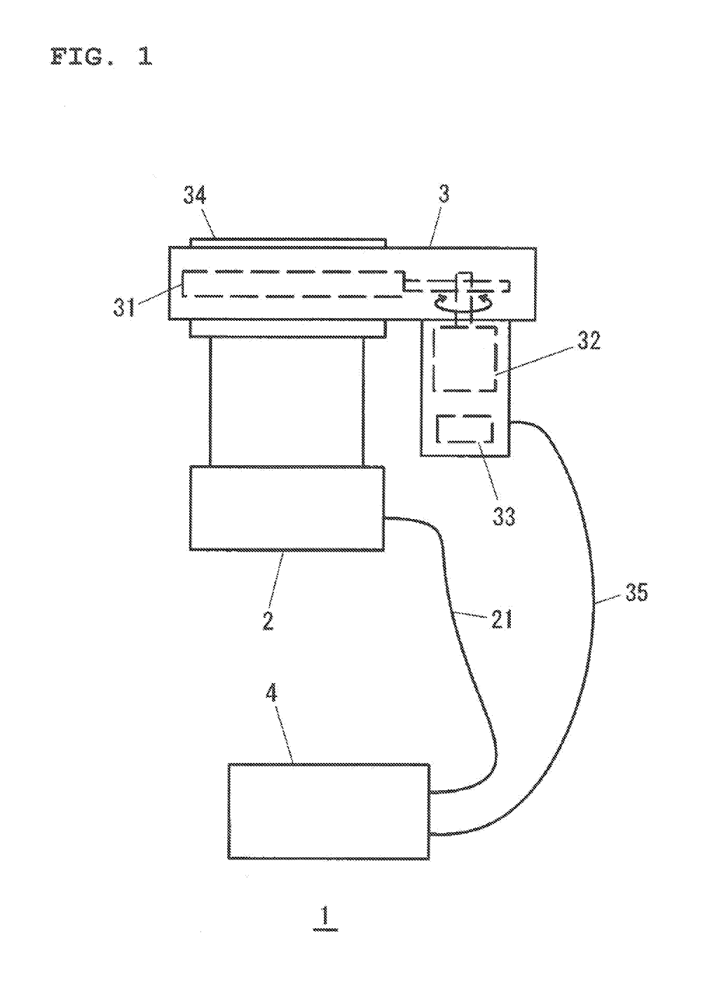

FIG. 1 is a drawing illustrating the appearance of an exhaust system 1 according to the present embodiment. The exhaust system 1 includes a turbo-molecular pump 2, a vacuum valve 3 provided on a suction port side of the turbo-molecular pump 2, and a control device 4 that controls each of the turbo-molecular pump 2 and the vacuum valve 3. The turbo-molecular pump 2 is connected to the control device 4 via a cable 21, and the vacuum valve 3 is connected to the control device 4 via a cable 35. A suction port 34 of the vacuum valve 3 is connected to a vacuum chamber or the piping of the vacuum chamber (not illustrated in the drawings).

A valve plate 31 is swing driven by a valve plate motor 32 to adjust the degree of opening of the valve plate 31. Thus, the vacuum valve 3 can be made to function as a pressure control valve for which valve conductance can be changed. A position detector 33 is provided in the valve plate motor 32 and the degree of opening of the valve plate 31 is calculated on the basis of a value detected by this position detector 33. A rotary encoder or the like is used for the position detector 33.

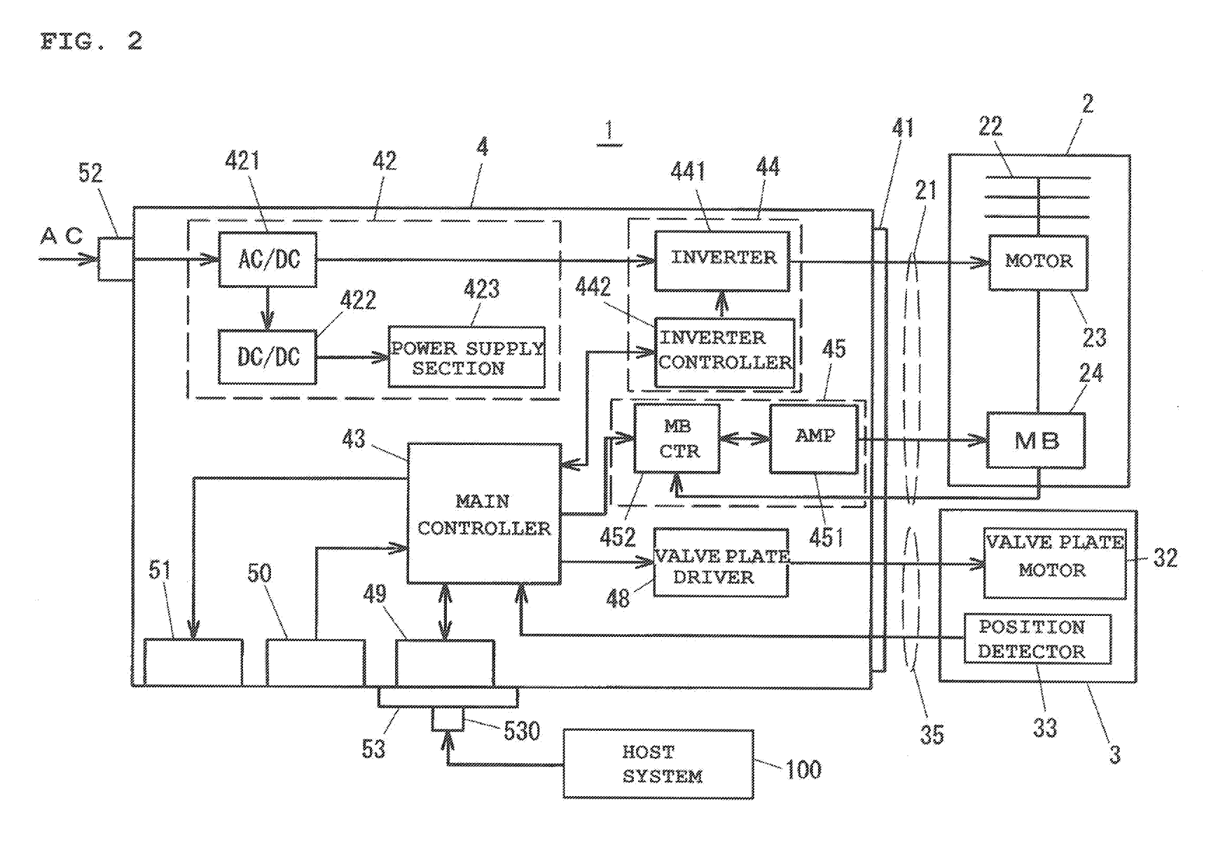

FIG. 2 is a block diagram illustrating a schematic configuration of the exhaust system 1. A pump rotor 22 provided in the turbo-molecular pump 2 is rotatably driven by a pump motor 23. The rotation shaft of the pump rotor 22 is non-contact supported by a magnetic bearing 24. As described above, the vacuum valve 3 includes the valve plate motor 32 and the position detector 33. The cable 21 of the turbo-molecular pump 2 and the cable 35 of the vacuum valve 3 are each connected to a connector (not illustrated in the drawings) provided on an interface panel 41 of the control device 4.

The control device 4 includes a power section 42, a main controller 43, a pump motor driver 44, a magnetic bearing driver 45, a valve plate driver 48, a communication section 49, an operation section 50, a display section 51, and the like. The pump motor driver 44 includes an inverter 441 and an inverter controller 442. The magnetic bearing driver 45 includes an excitation amplifier 451 and a magnetic bearing controller 452.

The exhaust system 1 operates on the basis of commands from a vacuum apparatus side controller, namely a host system 100. In the example illustrated in FIG. 2, commands from the host system 100 are input into a communication terminal 530 provided on an interface panel 53. Note that pressure measurement values of the vacuum chamber on which the exhaust system 1 is mounted are input into the main controller 43 via the communication section 49. The main controller 43 controls the valve driving on the basis of these pressure measurement values.

The power section 42 is provided with an AC/DC converter 421, a DC/DC converter 422, and a power supply section 423. AC power input into a power input section 52 from a commercial power supply (not illustrated in the drawings) is converted to DC power of a predetermined voltage by the AC/DC converter 421. The output of the AC/DC converter 421 is input into the inverter 441 and the DC/DC converter 422. The DC/DC converter 422 converts the DC power from the AC/DC converter 421 to DC power of an even lower voltage. The DC power output from the DC/DC converter 422 is supplied to the various components of the control device 4 via the power supply section 423.

A plurality of switching elements are provided on the inverter 441 that supplies power to the pump motor 23 of the turbo-molecular pump 2. The inverter controller 442 turns these switching elements ON and OFF. As a result, the pump motor 23 is rotatably driven. The inverter controller 442 performs ON/OFF control of the switching elements on the basis of commands from the main controller 43.

Generally, a five-axis control type magnetic bearing is used for the magnetic bearing 24. A displacement sensor (not illustrated in the drawings) that detects displacement of the rotation shaft is provided on the magnetic bearing 24, and sensor signals thereof are feedback inputted to the magnetic bearing controller 452. The magnetic bearing 24 includes one pair of electromagnets per axis and, therefore, the magnetic bearing 24 is provided with five pairs of, or 10 total, electromagnets when configured as a five-axis control type magnetic bearing. An excitation amplifier 451 is provided for each electromagnet and, therefore, 10 of the excitation amplifiers 451 are provided in the control device 4. PWM control signals are input from the magnetic bearing controller 452 to each excitation amplifier 451 in order to control the ON/OFF of switching elements provided on the excitation amplifiers 451. Current signals indicating current values flowing to each electromagnet are input from each excitation amplifier 451 to the magnetic bearing controller 452.

Commands for driving the vacuum valve 3 are input from the host system 100 on the vacuum apparatus side to the main controller 43 via the communication section 49. The main controller 43 controls the valve plate driver 48 on the basis of received commands. Note that, while not illustrated in the drawings, as with the pump motor driver 44 that drives the pump motor 23, the valve plate driver 48 that drives the valve plate motor 32 is constituted by an inverter and an inverter controller. The valve plate driver 48 drives the valve plate motor 32 on the basis of control signals from the main controller 43, and move the valve plate 31 in FIG. 1 to a target position.

An operator can perform various commands, data configurations, and the like by manually operating the operation section 50 provided in the control device 4. The states, configurations, and the like of the turbo-molecular pump 2 and the vacuum valve 3 are displayed on the display section 51.

The main controller 43 is constituted by a digital arithmetic section such as a field programmable gate array (FPGA) and peripheral circuits thereof. When using an FPGA, not only the control system of the main controller 43, but also the control systems of the inverter controller 442, the magnetic bearing controller 452, and the valve plate driver 48 can be consolidated by the FPGA. As a result, the cost and the size of the control device 4 can be reduced.

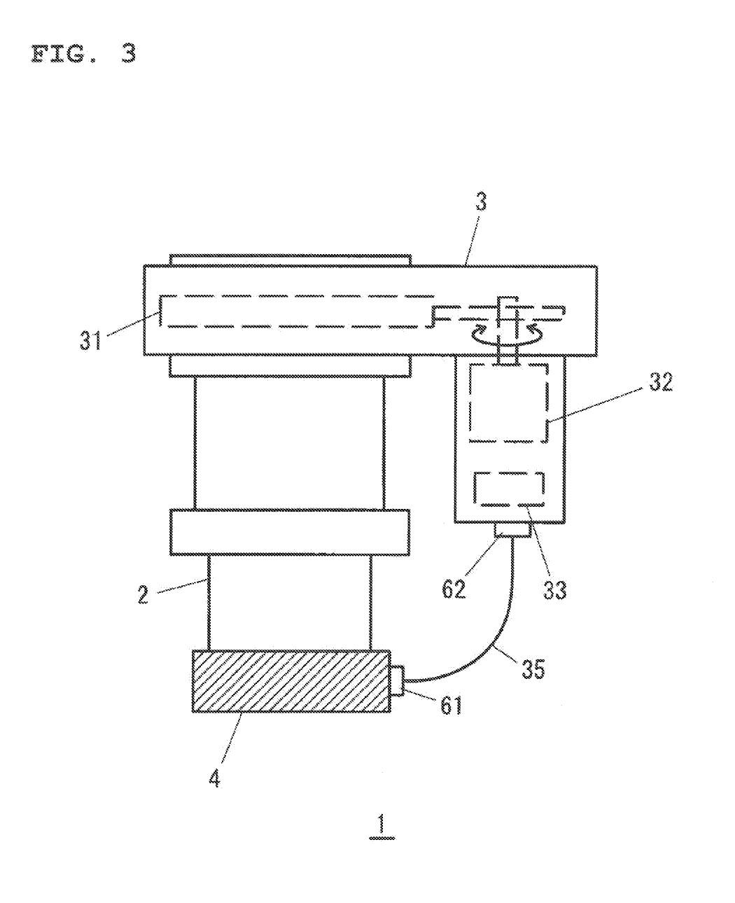

In the embodiment illustrated in FIGS. 1 and 2, the separate placement type control device 4 is connected with the turbo-molecular pump 2 and the vacuum valve 3 by the cables 21 and 35. However, the connection method is not limited thereto and, for example, configurations such as those illustrated in FIGS. 3 to 5 are possible. In a second example illustrated in FIG. 3, the control device 4 is provided on a base bottom surface of the turbo-molecular pump 2. The control device 4 is connected to the vacuum valve 3 by connecting the cable 35 to a connector 61 provided on the control device 4 and a connector 62 provided on the vacuum valve 3. The internal configuration of the control device 4 is similar to that illustrated in FIG. 2.

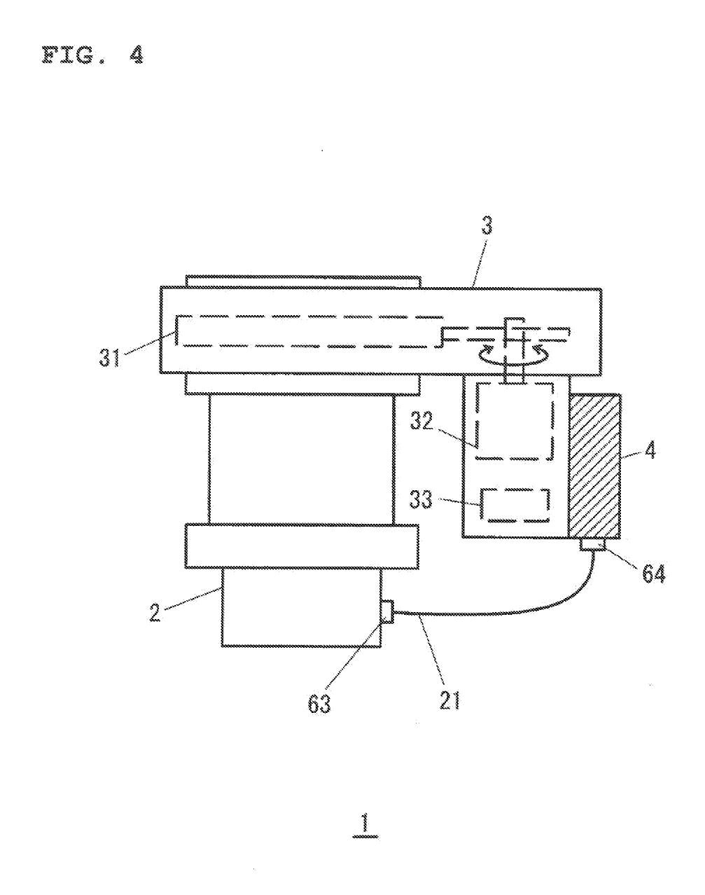

In a third example illustrated in FIG. 4, the control device 4 is provided on a side surface of a housing in which the valve plate motor 32 is housed. The control device 4 is connected to the turbo-molecular pump 2 by connecting the cable 21 to a connector 64 provided on the control device 4 and a connector 63 provided on the turbo-molecular pump 2. The internal configuration of the control device 4 is similar to that illustrated in FIG. 2.

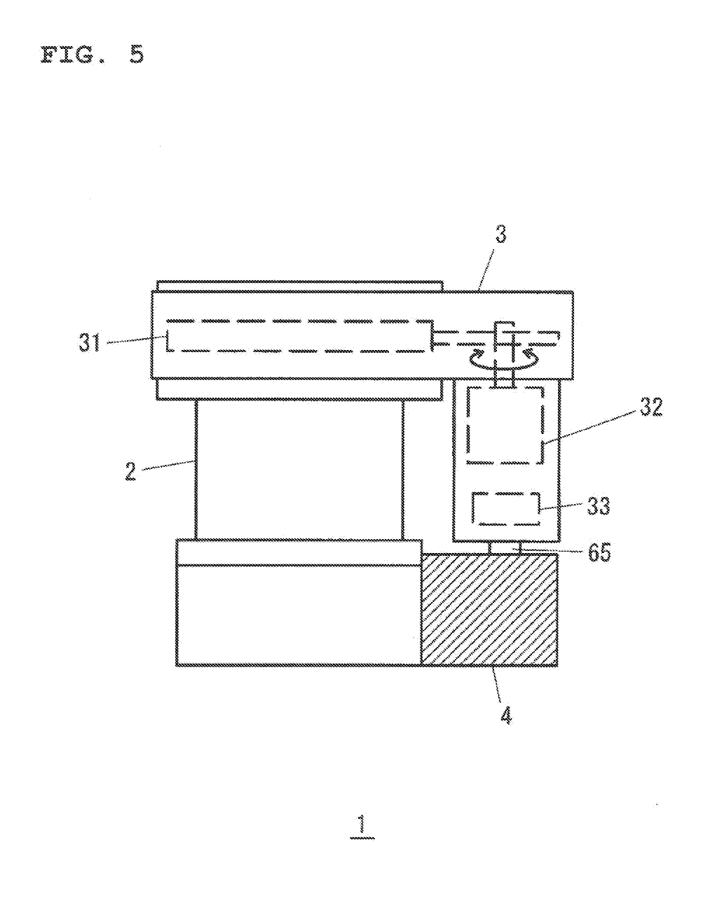

In a fourth example illustrated in FIG. 5, the control device 4 is provided on a base side surface of the turbo-molecular pump 2. The control device 4 is directly connected to the vacuum valve 3 by a connector 65. The internal configuration of the control device 4 is similar to that illustrated in FIG. 2.

In the related art, in configurations using a turbo-molecular pump and a vacuum valve, a pump control device is provided in the turbo-molecular pump and a valve control device is provided in the vacuum valve. As with the case of the control device 4 described above, pump control devices are configured to convert commercial AC power of an AC power supply to DC power using an AC/DC converter, and then convert a voltage of the resulting DC power to a desired DC voltage using a DC/DC converter. With valve control devices of vacuum valves, problems more easily occur. For example, the volume of the control device increases due to the converter being built-in and, as a result, interference caused by space restrictions may occur when the device is installed. As such, configurations in which the DC power supply is provided outside of the valve control device are common, and this leads to increased costs.

Additionally, in the present embodiment, a shared control device is used and, as such, the pump side operations and the valve side operations are both controlled by the main controller 43. As a result, cooperative operations, that is, operations requiring cooperation of the pump side and the valve side such as risk avoidance operations at the time of entering the atmosphere, can be more suitably performed.

In the present embodiment, the pump control device and the valve control device are integrated as the control device 4. Therefore, a configuration is achieved in which DC power is supplied from the shared power section 42 to the circuits related to the pump and the circuits related to the valve and, as a result, costs can be reduced. Additionally, the overall size of the control device 4 can be reduced compared to a case in which the pump control device and the valve control device are individually provided.

Moreover, in configurations where the pump control device and the valve control device are individually provided as in the related art, a controller corresponding to the main controller 43 illustrated in FIG. 2 is provided in each of the control devices. However, in the present embodiment, these constituents are controlled by the single main controller 43 and, as a result, costs can be reduced. Furthermore, because the FPGA is used, the functions of the main controller 43, the inverter controller 442, and the magnetic bearing controller 452 can be borne by the FPGA and, as a result, the size and the cost can be reduced.

The present embodiment is configured such that communications related to valve operations and communication related to pump operations are both carried out with the vacuum apparatus via a shared communication interface. However, with the configuration of the related art, in which individual control devices are provided for each of the pump and the valve, the communication system with the vacuum apparatus side interface requires two systems, namely a pump interface and a valve interface. As such, there is a drawback in that the communication structure is complicated.

### Alternate Embodiments

Products may become deposited in the exhaust system 1 (in the vacuum valve 3 and/or in the turbo-molecular pump 2) depending on the type of process to be carried out in the vacuum chamber. For example, when etching is performed in the vacuum chamber, products are likely to become deposited. Accordingly, in an alternate embodiment, to suppress product deposition, a temperature control function is added that adjusts the temperature to a predetermined target temperature by heating the turbo-molecular pump 2 and the vacuum valve 3 using a heater.

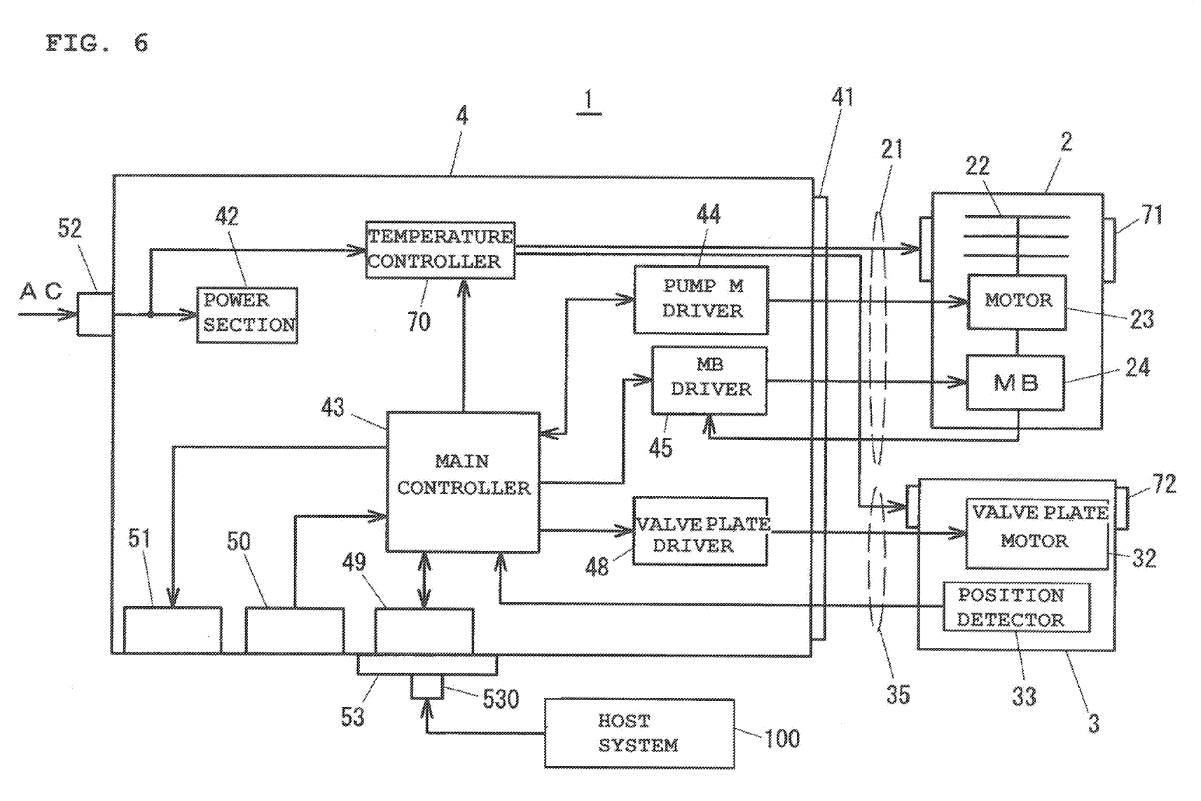

FIG. 6 is a drawing illustrating an example of the configuration of the exhaust system 1 according to the alternate embodiment. A heater 71 is mounted on the turbo-molecular pump 2, and a heater 72 is mounted on the vacuum valve 3. A temperature controller 70 controls the supply and stop of the current to the heaters 71 and 72. AC power input into the power input section 52 is input into the temperature controller 70. The temperature controller 70 controls the supply and stop of the power to the heaters 71 and 72 on the basis of control signals input from the main controller 43. As a result, control is carried out such that the temperature of the heated constituents reaches the target temperature. Temperature sensors (not illustrated in the drawings) that detect the temperature of the heated constituents or the heater temperature are provided on the turbo-molecular pump 2 and the vacuum valve 3. The main controller 43 outputs ON/OFF control signals to the temperature controller 70 on the basis of temperature detection information from the temperature sensors.

In configurations where the pump control device and the valve control device are individually provided as in the related art, a temperature controller is provided in each controller. However, in the control device 4 illustrated in FIG. 6, the pump side heater 71 and the valve side heater 72 are both controlled by the single temperature controller 70 and, as a result, costs can be reduced compared to the related art.

Various embodiments and alternate embodiments have been described, but the invention should not be construed to be limited thereto. Other embodiments, which can be derived within the technical concept of the invention, are also included within the scope of the invention. For example, the invention can be applied to an exhaust device using a turbo-molecular pump in which a magnetic bearing is not used or a vacuum pump other than a turbo-molecular pump. Additionally, the control device 4 described above may be used as the control device of the turbo-molecular pump alone.

What is claimed is:

1. A control device configured to control each of a vacuum pump and a vacuum valve provided on a side of a suction port of the vacuum pump, the control device comprising:
a motor driver configured to drive a rotor driving motor of the vacuum pump;
a valve plate driver configured to drive a valve plate driving motor of the vacuum valve; and
a controller configured to control the motor driver and the valve plate driver.

2. The control device according to claim 1, further comprising:
a power section configured to convert AC power to DC power and supply the DC power to each of the motor driver, the valve plate driver, and the controller.

3. The control device according to claim 1, further comprising:
a communication section configured to carry out communication related to valve operations and communication related to pump operations with an external device via a shared communication interface.

4. The control device according to claim 1, further comprising:
a single temperature controller configured to control a pump side heater provided on the vacuum pump and a valve side heater provided on the vacuum valve.

5. An exhaust system comprising:
a vacuum pump;
a vacuum valve mounted on a suction port of the vacuum pump; and
the control device according to claim 1.

6. The exhaust system according to claim 5, wherein
the control device is provided on a base bottom surface of the vacuum pump, and
the control device is connected to the vacuum valve by connecting a cable to a connector provided on the control device and a connector provided on the vacuum valve.

7. The exhaust system according to claim 5, wherein
the control device is provided on a side surface of a housing in which the valve plate driving motor is housed, and
the control device is connected to the vacuum pump by connecting a cable to a connector provided on the control device and a connector provided on the vacuum pump.

8. The exhaust system according to claim 5, wherein
the control device is provided on a base side surface of the vacuum pump, and
the control device is directly connected to the vacuum valve by a connector.
